(19) United States
(12) Patent Application Publication
(10) Pub. No.: US 2004/0081297 A1
(43) Pub. Date: Apr. 29, 2004

(54) Smart answering phone

(76) Inventors: Ching-sung Ho, Tauyuan City (TW); Su-Hong Tseng, Taipei City (TW); Hsi-Cheng Yeh, Taoyuan (TW); Chan-Li Liang, Anding Shiang (TW)

Correspondence Address: BIRCH STEWART KOLASCH & BIRCH, PO BOX 747, FALLS CHURCH, VA, 22040-0747, US

(21) Appl. No.: 10/644,030

(22) Filed: Aug. 20, 2003

(30) Foreign Application Priority Data
Oct. 25, 2002 (TW) 091125228

(51) Int. Cl. H04M 1/64; H04M 1/00

(52) U.S. Cl. 379/88.19; 379/373.01

(57) ABSTRACT

A method for answering a call from a remote terminal with a smart phone. The method comprises the steps of pre-storing a sound clip in the smart phone, receiving the call and acquiring a caller identity delivered therewith from the remote terminal, generating a selection signal corresponding to the caller identity, and selecting a voice signal derived from a microphone or from the sound clip to be transmitted to the remote terminal according to the selection signal.

### BACKGROUND OF THE INVENTION

1. Field of the Invention

The present invention relates to an answering machine and particularly to a smart answering phone featuring in automatic selection of outgoing messages.

2. Description of the Prior Art

Mobile phones are very popular portable communication devices. There are, however, many situations in which the mobile phone use is inappropriate, such as during a meeting, reading in a library or watching a movie. Furthermore, the mobile phone does not receive any incoming calls if it is out of the network service range.

For these situations, service providers offer a voice message box to the subscriber. Incoming calls are transferred to the voice message service when the user is unavailable. These messages are recorded and stored in the message box dedicated to the receiver. As soon as the receiver enters the network service area, the system informs the user that there are messages in the message box.

Additionally, the service system also allows the subscriber to record outgoing messages which a caller will hear before being prompted to record a message for the receiver.

However, since the outgoing message is the same for all incoming callers, it is troublesome for a user to leave a specific outgoing message for a specific caller. For example, when a user is in a meeting, and would like to leave a specific outgoing message for a specific. Currently this is only possible by changing the outgoing message which all incoming callers hear.

### SUMMARY OF THE INVENTION

The object of the present invention is to provide a smart answering phone featuring an automatic selection of outgoing messages.

The present invention provides a method for answering a call from a remote terminal with a smart phone. The method comprises the steps of pre-storing a sound clip in the smart phone, receiving the call and acquiring a caller identity delivered therewith from the remote terminal, generating a selection signal corresponding to the caller identity, and selecting a voice signal derived from a microphone or from the sound clip to be transmitted to the remote terminal according to the selection signal.

The present invention further provides a smart answering phone comprising a microphone, a Codec pre-storing a sound clip, a processor acquiring a caller identity delivered with a call from the remote terminal, and a multiplexer selecting a voice signal from the microphone or from the sound clip to be transmitted to the remote terminal.

The present invention also provides a method for answering a call from a remote terminal with a smart phone having a microphone, Codec, processor and multiplexer. The method comprises the steps of pre-storing a sound clip in the Codec, acquiring a caller identity delivered with the call received by the smart phone from the remote terminal, generating a selection signal by the processor corresponding to the caller identity, and selecting by the multiplexer a voice signal derived from a microphone or from the sound clip to be transmitted to the remote terminal according to the selection signal.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a diagram showing a smart answering phone according to one embodiment of the invention.

FIG. 2 is a flowchart of a method for answering a call from a remote terminal with a smart phone according to one embodiment of the invention.

### DETAILED DESCRIPTION OF THE INVENTION

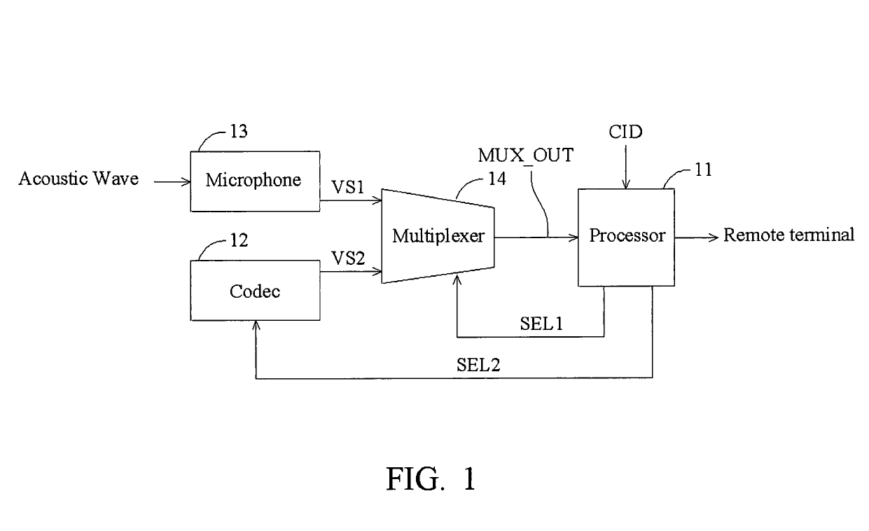

FIG. 1 is a diagram showing a smart answering phone according to one embodiment of the invention. The smart answering phone includes a microphone 13, a Codec 12, a processor 11 and a multiplexer 14. The microphone 13 converts an acoustic wave to an electrical voice signal VS1. The Codec 12 pre-stores sound clips recorded by the user. When a call is received from a remote terminal, the processor 11 acquires a caller identity CID delivered with the call and generates selection signals SEL1 and SEL2 according to the caller identity CID. The Codec 12 selects one of the sound clips corresponding to the selection signal SEL2 from the processor 11 and generates a voice signal VS2 by decoding the selected sound clip to the multiplexer 14. The multiplexer 14 selects one of the voice signals VS1 and VS2 to be sent to the processor 11 according to the selection signal SEL1. Finally, the selected voice signal is transmitted through processor 11 to the remote terminal.

The operation of the smart answering phone is described in the following. There are three possible incoming calls from A, B and C which are set to be outgoing directly, with a first and second recorded message respectively. When A is calling, the processor 11 sends out the selection signal SEL1 for the multiplexer 14 to select the voice signal VS1 from the microphone 13 to be transmitted to A. Thus, the user answers A directly on the phone. When B is calling, the processor 11 sends out the selection signal SEL2 for the Codec 12 to select the sound clip of the first recorded message as the source of the voice signal VS2 and also sends out the selection signal SEL1 for the multiplexer 14 to select the voice signal VS2 to be transmitted to B. Thus, B is outgoing with the first recorded message. When C is calling, the processor 11 sends out the selection signal SEL2 for the Codec 12 to select the sound clip of the second recorded message as the source of the voice signal VS2 and also sends out the selection signal SEL1 for the multiplexer 14 to select the voice signal VS2 to be transmitted to C. Thus, C is outgoing with the first recorded message.

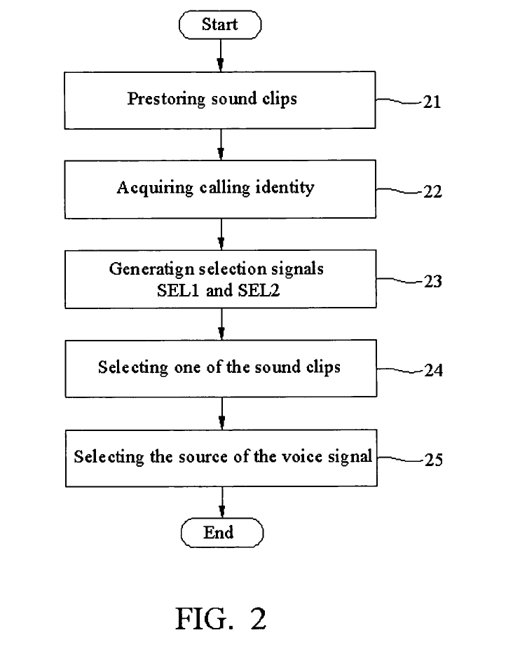

FIG. 2 is a flowchart of a method for answering a call from a remote terminal with a smart phone according to one embodiment of the invention.

In step 21, sound clips are pre-stored in a Codec.

In step 22, a caller identity is delivered with the call received by the smart phone from the remote terminal is acquired.

In step 23, selection signals SEL1 and SEL2 are generated by a processor according to the caller identity.

In step 24, one of the sound clips is selected by the Codec according to the selection signal SEL2.

In step 25, a voice signal derived from a microphone or from the selected sound clip is output by the multiplexer to be transmitted to the remote terminal according to the selection signal SEL1.

In conclusion, the present invention provides a smart answering phone and a method for answering a call from a remote terminal with a smart phone. The outgoing messages are automatically selected according to caller identity. Thus, the phone user can leave different messages to different callers.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for answering a call from a remote terminal with a smart phone, the method comprising the steps of:
pre-storing a sound clip in the smart phone;
receiving the call and acquiring a caller identity delivered therewith from the remote terminal;
generating a first selection signal corresponding to the caller identity; and
selecting a voice signal derived from a microphone or from the sound clip to be transmitted to the remote terminal according to the first selection signal.

2. The method as claimed in claim 1, wherein the smart phone further has a Codec and the method further comprises the step of:
pre-storing a plurality of sound clips;
generating a second selection signal corresponding to the caller identity; and
selecting one of the sound clips as a source of the voice signal according to the second selection signal.

3. A smart answering phone comprising:
a microphone;
a Codec pre-storing a sound clip;
a processor acquiring a caller identity delivered with the call from a remote terminal; and
a multiplexer selecting a voice signal from the microphone or from the sound clip to be transmitted to the remote terminal.

4. The smart answering phone as claimed in claim 3, wherein the Codec further pre-stores a plurality of sound clips, the processor further generates a second selection signal corresponding to the caller identity and the Codec further selects one of the sound clips as a source of the voice signal according to the second selection signal.

5. A method for answering a call from a remote terminal with a smart phone having a microphone, Codec, processor and multiplexer, the method comprising the steps of:
pre-storing a sound clip in the Codec;
acquiring a caller identity delivered with the call received by the smart phone from the remote terminal;
generating a selection signal by the processor corresponding to the caller identity; and
selecting by the multiplexer a voice signal derived from a microphone or from the sound clip to be transmitted to the remote terminal according to the selection signal.

6. The method as claimed in claim 5 further comprising the step of:
pre-storing a plurality of sound clips in the Codec;
generating by the processor a second selection signal corresponding to the caller identity; and
selecting by the Codec one of the sound clips as a source of the voice signal according to the second selection signal.
